(19) United States
(12) Patent Application Publication
(10) Pub. No.: US 2010/0231155 A1
(43) Pub. Date: Sep. 16, 2010

(54) CONTROLLER UNIT WITH INTEGRATED TEMPERATURE SENSOR

(75) Inventors: Claus Schmidt, Odense NV (DK); Dirk Homuth, Flensburg (DE)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 12/620,127

(22) Filed: Nov. 17, 2009

(30) Foreign Application Priority Data
Nov. 18, 2008 (DK) PA 2008 01608

(51) Int. Cl. H02H 7/08

(52) U.S. Cl. 318/473

(57) ABSTRACT

The present invention relates to a controller unit adapted to be releaseably attached to a corresponding terminal arranged on an exterior surface portion of a motor-driven compressor. The controller unit according to the present invention comprises an electrically isolating carrier member having one or more electrically conductive paths arranged thereon for transporting electrical power signals, the carrier member further having at least one thermally conductive path arranged thereon for transporting heat to a heat sensitive element of the controller unit in order to determine the temperature of the motor of the compressor. The present invention further relates to a method for carrying out the present invention.

### CROSS REFERENCE TO RELATED APPLICATION

Applicant hereby claims foreign priority benefits under U.S.C. §119 from Danish Patent Application No. PA 2008 01608 filed on Nov. 18, 2008, the contents of which are incorporated by reference herein.

### FIELD OF THE INVENTION

The present invention relates to a controller unit for a motor. In particular, the present invention relates to a controller unit having an integrated temperature sensor for measuring the temperature of a winding of an electric motor adapted to drive a compressor.

### BACKGROUND OF THE INVENTION

Household compressors normally have a sealed housing containing a motor and a compressor. The motor is typically a single phase motor having a main winding and a start winding which is used to start the motor. The starting process is controlled by a starter unit fixed external to the housing of the compressor.

The starter unit normally plugs onto a three pin construction which sticks out of the housing and corresponds to the three leads to the main winding, the start winding and their common end. An example of a suitable three pin construction is that supplied by the Fusite® company of Cincinnati, Ohio, USA. It is important that some protection is built into the system so that the motor does not get too hot in use. Often this protection includes an external temperature sensor which is placed on, or adjacent to, the housing. The external temperature sensor detects the temperature of the housing which in turn is dependent upon the temperature of the motor. Such externally mounted sensors are subject to other influences, such as ambient air temperature. Moreover, externally mounted sensors may not react quickly to temperature changes of the motor since the heat pathway is relatively long.

Other compressors use an internal protector device which is placed in series with the main winding and which is placed in or near to the motor winding to be monitored. The internal protector device responds to temperature changes of the winding as well as to the current flowing through it, and will disconnect the main winding if it detects too high a temperature or current. As the main winding cools down, the protector device reconnects, and the motor can be restarted.

EP 0 484 077 and U.S. Pat. No. 4,646,195 are both directed towards externally arranged mechanical solutions where the drive current to the motor in the compressor is monitored and disconnected by mechanical means. The mechanical solution provided in EP 0 484 077 involves a biased spring which permanently disconnects the motor current at a given motor temperature. U.S. Pat. No. 4,646,195 is also directed towards a spring-based solution.

It is an object of the present invention to provide a controller unit having an electronic temperature sensor integrated therewith and thus arranged outside of the motor housing.

It is a further object of the present invention to provide a controller unit having a programmable electronic temperature sensor incorporated therein.

### SUMMARY OF THE INVENTION

The above-mentioned objects are complied with by integrating a temperature sensor into the controller unit which is releaseably attached to the three connector pins arranged on the exterior of the compressor housing. Following this approach the temperature sensor becomes more accessible, easier to change and maintain. The temperature sensor of the controller unit is in thermal contact with the motor winding by being in close thermal contact with one or more of the pins. The pins are in turn connected to the motor windings by heat conducting cables. They are thus in better thermal contact with the motor windings than a temperature sensor merely mounted adjacent to the compressor housing.

In a first aspect the present invention relates to a controller unit adapted to determine a temperature of a motor, the controller unit comprising
means for releaseably attaching the controller unit to a corresponding controller terminal of a motor,
an electrically isolating carrier member having one or more electrically conductive paths arranged thereon for transporting electrical currents, the carrier member further having at least one thermally conductive path arranged thereon for transporting heat to a heat sensitive element of the controller unit in order to determine the temperature of the motor.

Preferably, controller unit is adapted to be releaseably attached to a controller terminal arranged on an exterior surface portion of a motor housing.

The controller unit according to the present invention substitutes both internal and external protectors known from prior art systems. The controller unit according to the present invention can be made much more precisely than existing motor protectors. Furthermore, the controller can be implemented with the use of a microprocessor, an ASIC, or any other suitable controller where the specifications can be configured to fit a specific compressor. The specifications may be programmed either by hardware or software during production of the controller unit.

In principle, the controller unit is configurable for any type of motor. Thus, the controller unit is suitable for both single and multiphase motors.

However, one particularly interesting application of the first aspect of the present invention is single phase motors operationally connected to compressors. Even though not limited to compressor applications the invention will, in the following, be described with reference to such applications.

The carrier member may comprise a number of through-going openings, each through-going opening being adapted to receive a pin-shaped contact element.

Contact means for establishing electrical contact between the electrically conductive paths and the respective pin-shaped contact members may be provided. Moreover, at least one of the contact means may be adapted to establish thermal contact between the thermally conductive path and a selected pin-shaped contact member, preferably a common pin which is electrically connected to both the starting winding and the main winding of the motor. The contact means may be shaped so as to establish a proper and stable connection between the contact means and pin-shaped contact members. For example the contact means may be shaped as a resilient cylinder having a through-going slit arranged in the longitudinal direction of the cylinder wall.

Preferably the carrier member comprises a printed circuit board (PCB). PCBs may advantageously be used since electrically and thermally conducting paths of for example copper may be provided using standard fabrication processes within the field of PCB processing.

The electrically and the thermally conductive paths may be arranged on the same side of the PCB. In fact, the electrically and the thermally conductive paths may be constituted by the same path. Alternatively, the electrically and the thermally conductive paths may be arranged on opposite sides of the PCB.

The heat sensitive element may comprise a thermistor, the thermistor being secured to the carrier member. The thermistor may be thermistor having a positive temperature coefficient (PTC) or a negative temperature coefficient (NTC). Preferably, a NTC thermistor is applied.

The controller unit may further comprise current sensing means adapted to measure a current supplied to the motor. Preferably, the current sensing means comprises a part which forms an integral part of an electrically conductive path of the carrier member. The current passing through the current sensing means may be determined by measuring a voltage generated across the current sensing means. Since the resistance of the current sensing means is known the current can be calculated using Ohm's law.

Alternatively, the current may be determined from an amount of heat being generated by the current sensing means. By positioning the heat sensitive element in an appropriate position relative to the current sensing means, the current provided to the motor may be determined from a signal generated by the heat sensing element. One way of positioning the current sensing means and the heat sensing element relative to each other involves positioning them on opposite sides of a PCB—preferably right above each other.

In a second aspect, the present invention relates to a method for determining a temperature of a motor, the determination being based on a measurement of a temperature of a pin-shaped element being electrically and thermally connected to at least one winding of the motor, the method comprising the steps of
releaseably attaching a controller unit to a corresponding terminal of the motor, the controller unit comprising an electrically isolating carrier member having at least one thermally conductive path arranged thereon for transporting heat from the pin-shaped element to a heat sensitive element arranged on said carrier member, and
determining a value of an electrical parameter of said heat sensitive element, said value being a measure for the temperature of the motor.

The value of the electrical parameter may be a resistance, said resistance being a variable resistance of a thermistor, such as a NTC thermistor.

The method may further comprise a step of determining a current supplied to the at least one winding of the motor. As mentioned in connection with the first aspect of the present invention, the current may be determined by measuring a voltage drop across a current sensing element provided on the carrier member. Alternatively, the current may be determined by measuring an output signal from the heat sensitive element, said output signal being dependent on the current supplied to the motor. Preferably, the temperature of the motor and the current supplied to the motor is determined essentially simultaneously.

In a third aspect, the present invention relates to use of a controller unit according to the first aspect of the present invention for determining a temperature of a motor, said motor being operatively connected to a compressor.

In a fourth aspect, the present invention relates to a programmable controller unit adapted to determine a temperature of a motor, the controller unit comprising
means for releaseably attaching the controller unit to a corresponding controller terminal of a motor,
an electrically isolating carrier member having at least one thermally conductive path arranged thereon, the at least one thermally conductive path being adapted to transport heat from a pin-shaped element of the motor to a heat sensitive element of the controller unit, and
an integrated circuit being pre-programmed in order to comply with motor-related data of a given type of motor, the integrated circuit being adapted to process signal from the heat sensitive element.

The integrated circuit may comprise an ASIC arranged on the electrically isolating member, the latter preferably comprising a PCB.

Preferably, the integrated circuit is adapted to disconnect current supplied to the motor if the temperature of the motor exceeds a pre-defined limit. This pre-defined limit may be pre-loaded into the integrated circuit during manufacturing thereof. The integrated circuit may be customized/programmed to match specific motor data or specific applications.

### BRIEF DESCRIPTION OF THE DRAWINGS

The present invention will now be explained in further details with reference to the accompanying figures wherein

FIG. 1 shows a top view of a PCB layout according to a first embodiment,

FIG. 2 shows a bottom view of a PCB layout according to the first embodiment,

FIG. 3 shows a top view of a PCB according to a second embodiment,

FIG. 4 shows a top layer layout of the second embodiment,

FIG. 5 shows a bottom layer layout of the second embodiment, and

FIG. 6 shows a top view of a PCB layout according to a third embodiment.

### DETAILED DESCRIPTION OF THE INVENTION

In its most general aspect the present invention relates to a controller unit being releaseably attachable to the three pins of a motor, such as a motor operatively connected to a compressor. Electrical and thermal connections to the three pins are provided by electrically and thermally conducting paths arranged on a single or double sided PCB. The temperature of the motor, which may be positioned inside the compressor housing, is measured by determining the temperature of one of the pins by a NTC thermistor or any other thermal measurement element being mounted on the PCB. Since the pins are thermally connected to the windings of the motor the temperature of one of the pins, typically the common pin, provides a measure for the temperature of the motor. The common pin is connected to both the start winding and the main winding of the motor.

A relay contact is typically inserted in series with the supply voltage line to the main winding of the motor of the compressor. This relay is turned off in case the temperature measured on the common pin exceeds a predefined limit.

One way of providing thermal contact between for example the common pin and the NTC thermistor is to provide a copper area around the common pin and positioning the NTC thermistor on said area to ensure a low thermal resistance from the common pin to the NTC thermistor.

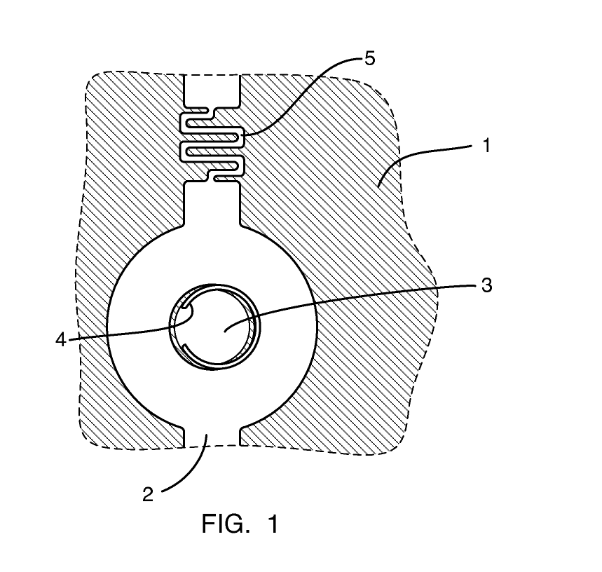

Referring now to FIG. 1 a surface of a PCB 1 is depicted. The surface has an electrically conductive path 2 arranged thereon. A through-going opening 3 is provided in the PCB and the electrically conductive path 2. This opening 3 is adapted to receive the common pin (not shown). A clip 4 for engaging with the pin is provided in order to establish an electrical connection between said pin and the electrically conductive path 2. Thus, electrical current may be provided to the pin via the electrically conductive path 2 and the clip 4.

A resistive element 5 is integrated with the electrically conductive path 2. The resistive element 5 has a well-defined resistance so that by measuring the voltage drop across it the current flow through the resistive element 5, and thereby the current provided to the motor, can be determined. This measurement of the current can be used by a motor controller to limit the current supplied according to a predefined or dynamically defined limit. This limit can be pre-programmed in software or hardware at the time that the controller unit is assembled or commissioned. Hardware setting can be by the means, for example, of resistors on a circuit board. The resistance of the resistive element 5 is dependent upon the motor current and is chosen typically to give a heating effect of around 0.5 Watt. The electrically conductive path 2 including the integrated resistive element 5 can be fabricated of various electrically conductive materials, such as for example copper. However, other materials may also be applicable.

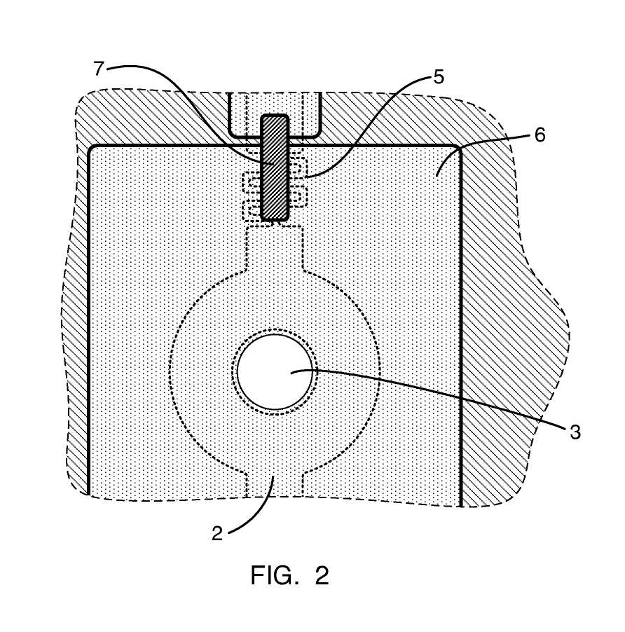

Alternatively, the current supplied to the motor can be determined from the amount of heat generated by the resistive element 5. In fact, the resistive element 5 produces heat which is related to the current though the element. This heat causes a temperature rise on the opposite side of the PCB which is where the heat sensitive element 7 (cf. FIG. 2) is mounted. Thus, the temperature rise measured by the heat sensitive element 7 is caused by either the current through the resistive element 5 or the temperature rise of the pin, or both.

FIG. 2 shows the opposite side of the PCB depicted in FIG. 1. The electrically conductive path 2 and the resistive element 5 are depicted with dashed lines to indicate that they are positioned on the opposite side of the PCB. A thermally conductive element 6 is arranged around the through-going opening 3. This thermally conductive element 6 is provided for establishing a thermal connection between the pin entering the opening 3 and a heat sensitive element 7 arranged on the thermally conductive element 6. As previously stated, the temperature rise measured by the heat sensitive element 7 is caused by either the current through the resistive element 5 or the temperature rise of the pin entering the opening 3, or both.

The thermally conductive element 6 may be constituted by a copper layer being appropriately shaped.

The heat sensitive element may comprise various devices, such as a PTC or a NTC thermistor or an RTD (resistance temperature detector) device such as a platinum resistance element comprising, for example, a thin film or a wire wound resistance element. Preferably, a NTC thermistor is applied. Thus, when the pin is positioned in the through-going opening 3 a thermal connection is established between said pin and the thermally conductive element 6. In this way the temperature of the thermally conductive element 6 substantially equals the temperature of the pin. Since the temperature of the pin is substantially equal to the temperature of the phase winding due to their electrical and thermal interconnecting the temperature of the motor is determinable. Preferably the pin to be positioned in the trough-going opening is the so-called common pin which is connected to both the start winding and the main winding of the motor.

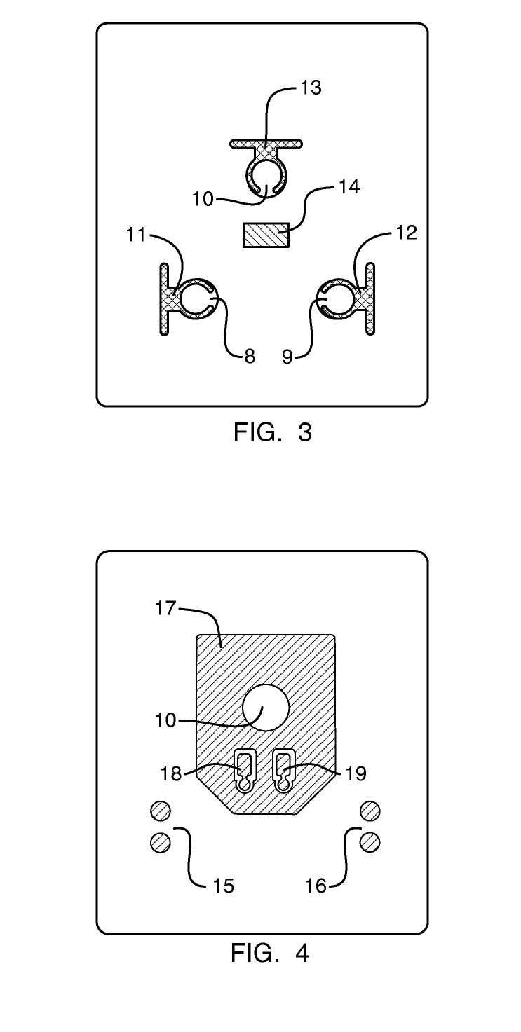

FIGS. 3-5 show another embodiment of the present invention. FIG. 3 shows a top view of a PCB having three through-going openings 8, 9, 10 arranged therein. These three through-going openings are adapted to receive three pins of an associated compressor. Electrical and thermal contact to the pins are provided by three connection clips 11, 12, 13. In order to determine the temperature of a pin a NTC thermistor 14 is provided near the centre of the PCB.

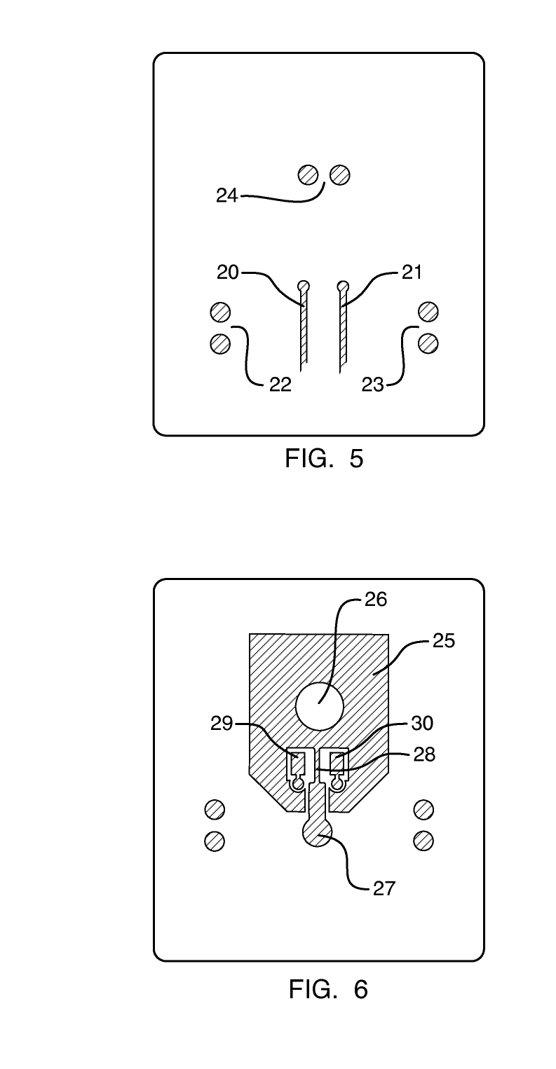

Preferably, the PCB is a multilayer PCB having a plurality of mutually and electrically isolated copper layers. A layout of a top layer is shown in FIG. 4. As seen the top layer includes pairs mounting pads 15, 16 for the connection clips 11, 12. Moreover, an electrically and thermally conductive element 17 is provided. The aim of this electrically and thermally conductive element is to provide electrical power signals to the pin positioned in the opening 10. The temperature of the pin positioned in opening 10 is transferred to the NTC thermistor via the electrically and thermally conductive element 17. The resistance of the NTC thermistor, and thereby the temperature of the pin, is measurable via NTC contact pads 18, 19. The mounting pads 15, 16, the NTC contact pads 18, 19 and the electrically and thermally conductive element 17 are all electrically connected to respective pads/tracks of another copper layer, see FIG. 5. Thus, through-going connections are provided between the NTC contact pads 18, 19 and the respective lead out tracks 20, 21. The lead out tracks 20, 21 are electrically connected to a suitable measuring system (not shown). The electrically and thermally conductive element 17, the mounting pads 15 and the mounting pads 16 are electrically connected via through-going PCB connections to contact pads 24, contact pads 22 and contact pads 23, respectively. Contact pads 22, 23 and 24 are electrically connected to external equipment via additional lead out tracks (not shown). Such additional external equipment typically involves a power supply, controllable switches etc.

FIG. 6 shows an alternative embodiment of the layout shown in FIG. 1. FIG. 6 shows a PCB comprising an electrically conductive path 25 for providing current to a pin (not shown) inserted in the opening 26. The current is provided from an external power source to the pad 27 and passes through the resistive element 28 on its way to the pin (not shown) of the motor. The embodiment shown in FIG. 6 will typically involve a clip for establishing an electrical connection between the pin of the motor and the electrically conductive path 25. Current that passes through the resistive element 28 will induce a temperature rise in the element. This temperature rise is measurable if a heat sensing element is positioned right above the resistive element on the opposite side of the PCB. The heat sensitive element, typically being an NTC thermistor, is connected to NTC contact pads 29, 30. Thus, a temperature increase due to power dissipation in said element 28 is measurable via the heat sensitive element. Moreover, a temperature increase measured by the heat sensitive element may be caused by a temperature rise of the pin entering the opening 26.

While the invention is susceptible to various modifications and alternative forms, specific embodiments have been shown by way of example in the figures and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

What is claimed is:

1. A controller unit adapted to determine a temperature of a motor, the controller unit comprising;
means for releaseably attaching the controller unit to a corresponding controller terminal of a motor,
an electrically isolating carrier member having one or more electrically conductive paths arranged thereon for transporting electrical currents, the carrier member further having at least one thermally conductive path arranged thereon for transporting heat to a heat sensitive element of the controller unit in order to determine the temperature of the motor.

2. The controller unit according to claim 1, wherein the unit is adapted to be releaseably attached to a controller terminal arranged on an exterior surface portion of a motor housing.

3. The controller unit according to claim 1, wherein the carrier member comprises a number of through-going openings, each through-going opening being adapted to receive a pin-shaped contact element.

4. The controller unit according to claim 3, further comprising contact means for establishing electrical contact between the electrically conductive paths and the respective pin-shaped contact members.

5. The controller unit according to claim 4, where at least one of the contact means is adapted to establish a thermal connection between the thermally conductive path and a selected pin-shaped contact member.

6. The controller unit according to claim 1, wherein the carrier member comprises a PCB.

7. The controller unit according to claim 1, wherein the electrically and the thermally conductive paths are arranged on the same side of the carrier member.

8. The controller unit according to claim 1, wherein the electrically and the thermally conductive paths are arranged on opposite sides of the carrier member.

9. The controller unit according to claim 7, wherein the electrically and the thermally conductive paths are constituted by the same path.

10. The controller unit according to claim 1, wherein the heat sensitive element comprises a thermistor, the thermistor being secured to the carrier member.

11. The controller unit according to claim 10, wherein the thermistor is a NTC thermistor.

12. The controller unit according to claim 1, further comprising current sensing means adapted to measure a current supplied to the motor.

13. The controller unit according to claim 12, wherein the current sensing means comprises a part which forms an integral part of an electrically conductive path of the carrier member.

14. A method for determining a temperature of a motor, the determination being based on a measurement of a temperature of a pin-shaped element being electrically and thermally connected to at least one winding of the motor, the method comprising the steps of:
releaseably attaching a controller unit to a corresponding controller terminal operatively connected to the motor, the controller unit comprising an electrically isolating carrier member having at least one thermally conductive path arranged thereon for transporting heat from the pin-shaped element to a heat sensitive element arranged on said carrier member, and
determining a value of an electrical parameter of said heat sensitive element, said value being a measure for the temperature of the motor.

15. The method according to claim 14, wherein the value of the electrical parameter is a resistance, and wherein the heat sensitive element comprises a thermistor, such as a NTC thermistor.

16. The method according to claim 14, further comprising a step of determining a current supplied to the at least one winding of the motor.

17. The method according to claim 16, wherein the current is determined by measuring a voltage drop across a current sensing element provided on the carrier member.

18. The method according to claim 16, wherein the current is determined by measuring an output signal from the heat sensitive element, said output signal being dependent on the current supplied to the motor.

19. The method according to claim 16, wherein the temperature of the motor and the current supplied to the motor is determined essentially simultaneously.

20. Use of a controller unit according to claim 1 for determining a temperature of a motor, said motor being operatively connected to a compressor.

21. A programmable controller unit adapted to determine a temperature of a motor, the controller unit comprising:
means for releaseably attaching the controller unit to a corresponding controller terminal of a motor,
an electrically isolating carrier member having at least one thermally conductive path arranged thereon, the at least one thermally conductive path being adapted to transport heat from a pin-shaped element of the motor to a heat sensitive element of the controller unit, and
an integrated circuit being pre-programmed in order to comply with motor-related data of a given type of motor, the integrated circuit being adapted to process signal from the heat sensitive element.

22. The programmable control unit according to claim 21, wherein the integrated circuit comprises an ASIC.

23. The programmable control unit according to claim 21, wherein the integrated circuit is adapted to disconnect current supplied to the motor if the temperature of the motor exceeds a pre-defined limit value.
